(19) United States
(12) Patent Application Publication
(10) Pub. No.: US 2018/0277950 A1
(43) Pub. Date: Sep. 27, 2018

(54) PHASE SHIFTER AND ARRAY ANTENNA DEVICE

(71) Applicant: KABUSHIKI KAISHA TOSHIBA, Tokyo (JP)

(72) Inventors: Hiroaki IKEUCHI, Yokohama Kanagawa (JP); Tamio KAWAGUCHI, Kawasaki Kanagawa (JP); Noritsugu SHIOKAWA, Yokohama Kanagawa (JP)

(73) Assignee: KABUSHIKI KAISHA TOSHIBA, Tokyo (JP)

(21) Appl. No.: 15/691,384

(22) Filed: Aug. 30, 2017

(30) Foreign Application Priority Data
Mar. 21, 2017 (JP) 2017-054473

(51) Int. Cl. H01Q 3/36; H01Q 21/22

(52) U.S. Cl. CPC H01Q 3/36; H01Q 21/22

(57) ABSTRACT

An increase in size of a phase shifter is suppressed and a change amount of a passing phase is further increased. A phase shifter of an embodiment includes a signal input unit, first to fourth lines, a signal output unit, first and second phase variable elements, and a phase setter phase setter. The first line is connected to the signal input unit and the signal output unit. The second and the third lines branch from the first line at different points. The fourth line is connected to ends of the second and the third lines. The first phase variable element is connected to a connection point between the second and the fourth lines. The second phase variable element is connected to a connection point between the third and the fourth lines. The phase setter is connected to the first and the second phase variable elements. In addition, an electrical length and a characteristic impedance of the second line are the same as an electrical length and a characteristic impedance of the third line, and at least one of an electrical length and a characteristic impedance of the first line is different from an electrical length or a characteristic impedance of the fourth line.

### CROSS-REFERENCE TO RELATED APPLICATION

This application is based upon and claims the benefit of priority from Japanese Patent Application No. 2017-054473, filed Mar. 21, 2017; the entire contents of which are incorporated herein by reference.

### FIELD

Embodiments described herein relate generally to a phase shifter and an array antenna device.

### BACKGROUND

Conventionally, a phase shifter which physically changes an electrical length of a signal to generate a phase delay in an input signal and to make a phase variable is known. In addition, a phase shifter which connects phase variable elements to a hybrid circuit in which an electrical length of a signal line is set to 90° (¼ wavelength) in parallel and increases an amount of change in a reflection phase to increase an amount of change in an output passing phase is conventionally known. However, when an electrical length is physically changed, a signal line with a length in accordance with an amount of variation of phase of signal is required in some cases. In addition, since a plurality of phase variable elements are required to be connected to increase a phase amount changed by phase variable elements, a phase shifter may be greater in size.

### BRIEF DESCRIPTION OF THE DRAWINGS

FIG. 1 is a diagram for describing a confit ration of a phase shifter 100 of an embodiment.

FIG. 2 is a diagram for describing a reflection characteristic 200 when an electrical length of a signal line 110D is changed and an amount of variation of phase of signal 202 of a passing phase.

FIG. 3 is a diagram for describing a reflection loss when electrical lengths of signal lines 110B and 110C and an electrical length of a signal line 110A are changed.

FIG. 4 is a diagram for describing an amount of variation of phase of signal when the electrical lengths of the signal lines 110B and 110C and the electrical length of the signal line 110A are changed.

FIG. 5 is a diagram for describing a reflection loss when characteristic impedances of each of the signal lines 110B and 110C and a characteristic impedance of the signal line 110D are changed.

FIG. 6 is a diagram for describing an amount of variation of phase of signal when the characteristic impedances of the signal lines 110B and 110C and a characteristic impedance of the signal line 110D are changed.

FIG. 7 is a diagram which shows an example of comparing the passing phase in the phase shifter 100 of the embodiment and a phase shifter to be compared.

FIG. 8 is a diagram which shows a configuration example of an array antenna device 300 including the phase shifter 100 of the embodiment.

### DETAILED DESCRIPTION

An object of the present invention is to provide a phase shifter which can suppress an increase in size of the phase shifter and can further increase an amount of change in a passing phase, and to provide an array antenna device.

A phase shifter of an embodiment includes a signal input unit, first to fourth signal lines, a signal output unit, first and second phase variable elements, and a phase setter. The signal input unit is supplied with a signal. The first signal line has one end connected to the signal input unit. The signal output unit is connected to the other end of the first signal line. The second and the third signal lines branch from the first line at different points. The fourth signal line has one end connected to an end of the second signal line on an opposite side to a branch point from the first signal line and has the other end connected to an end of the third signal line on an opposite side to a branch point from the first signal line. The first phase variable element is connected to a connection point between the second signal line and the fourth signal line. The second phase variable element is connected to a connection point between the third signal line and the fourth signal line. The phase setter is connected to the first phase variable element and the second phase variable element. In addition, an electrical length and a characteristic impedance of the second signal line are same as an electrical length and a characteristic impedance of the third signal line, and at least one of an electrical length and a characteristic impedance of the first signal line is different from an electrical length or a characteristic impedance of the fourth signal line.

Hereinafter, a phase shifter of an embodiment and an array antenna device will be described with reference to the drawings.

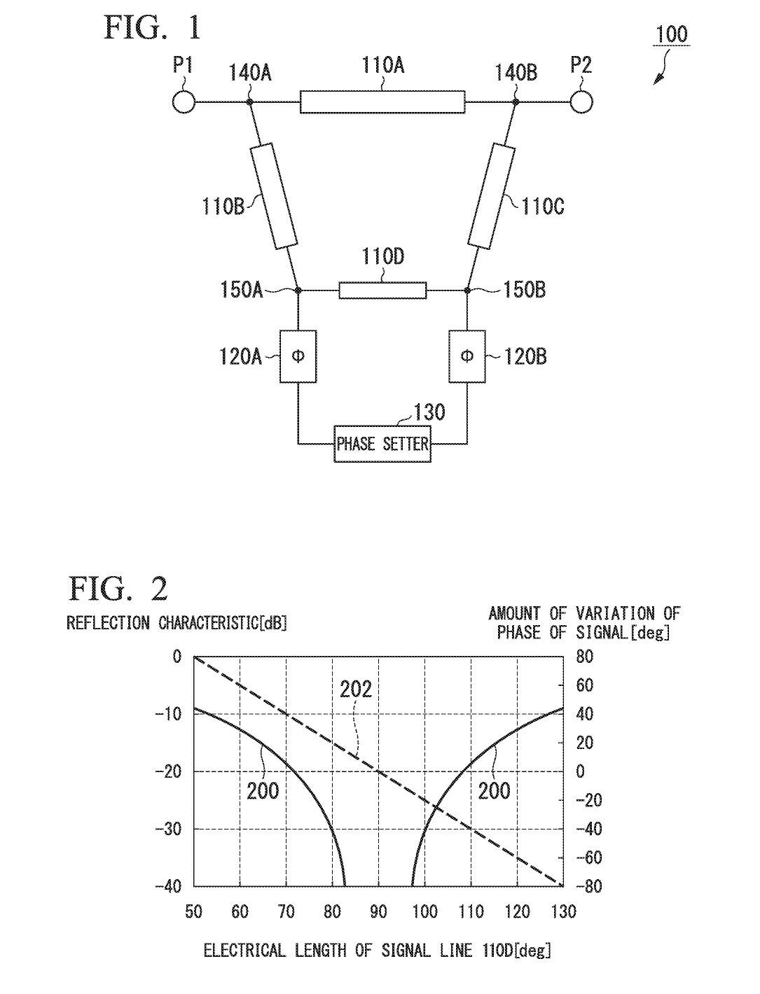

FIG. 1 is a diagram for describing a configuration of a phase shifter 100 of an embodiment. The phase shifter 100 includes a signal input unit P1, a signal output unit P2, signal lines 110A to 110D, phase variable elements 120A and 120B, and a phase setter 130.

The signal input unit P1 is supplied with a signal. The signal supplied to the signal input unit P1 is, for example, a received signal generated by an antenna element which is not illustrated or a transmission signal which is supplied to the antenna element. The signal input unit P1 is connected to one end of a signal line 110A.

A signal output unit P2 is connected to the other end of the signal line 110A, and is connected to the signal input unit P1 via the signal line 110A. The signal output unit P2 is supplied with a signal transmitted by the signal line 110A and outputs the supplied signal.

The signal line 110A has one end connected to the signal input unit P1 and the other end connected to the signal output unit P2. The signal line 110B and the signal line 110C are lines branching from the signal line 110A at different points. A branch point 140A between the signal line 110A and the signal line 110B is closer to the signal input unit P1 than a branch point 140B between the signal line 110A and the signal line 110C. The signal line 110D is connected to an end of the signal line 110B (an end on an opposite side to the branch point 140A), and has the other end connected to an end of the signal line 110C (an end on an opposite side to the branch point 140B).

The signal line 110A is a first signal line. The first signal line having a first end and a second end, the first end being connected to the signal input unit P1. A signal output unit P2 connected to the second end.

The signal line 110B is a second signal line. The second signal line having a third end and a fourth end, the third end being connected to the signal input unit P1 and the first end.

The signal line 110C is a third signal line. The third signal line having a fifth end and a sixth end, the fifth end being connected to the signal output unit P2 and the second end.

The signal line 110D is a fourth signal line. The fourth signal line having a seventh end and a eighth end, the seventh end being connected to the fourth end, and the eighth end being connected to the sixth end.

In addition, an electrical length and a characteristic impedance of the signal line 110B are the same as an electrical length and a characteristic impedance of the signal line 110C. Moreover, at least one of an electrical length and a characteristic impedance of the signal line 110A is different from an electrical length or a characteristic impedance of the signal line 110D. In other words, the signal line 110B and the signal line 110C are symmetrical with each other in terms of line condition. The signal line 110A and the signal line 110D are asymmetrical with each other in terms of line conditions. The line conditions include, for example, at least one of the electrical length and the characteristic impedance. Specific line conditions of each of the signal lines 110A to 110D will be described below.

In addition, the signal lines 110A to 110D are, for example, thin film conductors formed on a dielectric substrate. In addition, the signal lines 110A to 110D may include a material which is in a superconducting state below a predetermined temperature. It is possible to minimize loss in the signal lines 110A to 110D by setting the signal lines 110A to 110D to be in the superconducting state, in contrast to a case in which a normal conductive member is used.

As a material in the superconducting state, there is, for example, yttrium barium copper oxide (YBCO). It is necessary to cool a superconductor to a very low temperature to bring the superconductor into the superconducting state. However, YBCO is in the superconducting state at a high temperature (for example, 90 Kelvin (K) or more) in contrast to other superconductors. For this reason, when the material of the signal lines 110A to 110D includes YBCO, it is possible to more easily bring the signal lines 110A to 110D into the superconducting state than in a case in which other materials are used.

The phase variable element 120A is connected to a connection point 150A between the signal line 110B and the signal line 110D, The phase variable element 120B is connected to a connection point 150B between the signal line 110C and the signal line 110D.

The phase variable element 120A is a first phase variable element. The first phase variable element connected to a connection point between the second signal line and the fourth signal line. The phase variable element 120B is a second phase variable element. The second phase variable element connected to a connection point between the third signal line and the fourth signal line.

The phase variable elements 120A and 120B change an amount of change in a phase of signal reflected by changing an internal capacitance depending on a potential given to a line under a control by the phase setter 130. Accordingly, it is possible to change an amount of change in a passing phase of the phase shifter 100.

Moreover, the phase variable elements 120A and 120B are, for example, P-Intrinsic-N (PIN) diodes or varactor diodes. Low loss results from using these diodes as compared to using other diodes, In addition, since a varactor diode can be controlled with only a reverse bias voltage, hardly any current flows. Therefore, using these diodes can suppress heat generation of the phase variable elements 120A and 120B, and is particularly effective when the signal lines 110A to 110D containing a material in the superconducting state are used.

The phase setter 130 is realized, for example, by a processor such as a central processing unit (CPU) executing a program stored in a program memory. In addition, a portion or all of the phase setter 130 may be realized by hardware such as a large scale integration (LSI), an application specific integrated circuit (ASIC), or a field-programmable gate array (FPGA). The phase setter connected to both the phase variable elements 120A and 120B. The phase setter 130 performs control to increase the amount of change in each phase of signal reflected by applying a voltage to the phase variable elements 120A and 120B.

Next, a method of determining the electrical lengths of each of the signal lines 110A to 110D in the embodiment will be specifically described. In the following, an example in which a range of the electrical length of the signal line 110D is first determined and ranges of the electrical lengths of the other signal lines 110A to 110C are determined on the basis of the determined range of the electrical length of the signal line 110D will be described. In addition, an output of the phase shifter 100 when the electrical lengths of each of the signal lines 110A to 110D are changed under a predetermined condition will be described using simulation results in the following.

FIG. 2 is a diagram for describing a reflection characteristic 200 when the electrical length of the signal line 110D is changed and an amount of variation of phase of signal 202 of a passing phase. The horizontal axis of FIG. 2 represents the electrical length [deg] of the signal line 110D, the vertical axis on the left side thereof represents the reflection characteristic [dB] of the phase shifter 100, and the vertical axis on the right side thereof represents the amount of variation [deg] of the passing phase of the phase shifter 100. Moreover, the electrical lengths of the signal lines 110A to 110C are set to be fixed values (for example, 90 [deg](λ/4 wavelengths), and the characteristic impedances of the signal lines 110A to 110D are also set to be fixed values (for example, the characteristic impedance of the signal line 110A and 110D are Z₀=50 [Ω], and the characteristic impedances of the signal lines 110B and 110C are Z₀/√2 [Ω]).

When the electrical length of the signal line 110D is changed within a range of 50 to 130 [deg], the trends in the reflection characteristic 200 and the amount of variation of phase of signal 202 appear as shown in FIG. 2. Here, when a threshold value at which the reflection characteristic is regarded to be a low loss is set to −20 [dB], the range of the electrical length of the signal line 110D in which the reflection characteristic is the threshold value or below is about 70 to 110 [deg]. Moreover, a range in which the amount of variation of phase of signal 202 increases in the range of 50 to 130 [deg] of the electrical length of the signal line 110D is about 50 to 90 [deg] or less. If these results are combined, it is preferable that the range of the electrical length of the signal line 110D be set to about 70 to 90 [deg]. By setting the range of the electrical length of the signal line 110D to about 70 to 90 [deg], it is possible to increase the amount of variation of phase of signal compared to a case in which a 90° hybrid-type phase shifter is used while obtaining a low reflection characteristic.

Next, a method of determining the electrical lengths of the signal lines 110A to 110C will be described. FIG. 3 is a diagram for describing a reflection loss when the electrical lengths of the signal lines 110B and 110C and the electrical length of the signal line 110A are changed. The horizontal axis of FIG. 3 represents the electrical length [deg] of the signal lines 110B and 110C, and the vertical axis represents the electrical length [deg] of the signal line 110A.

When the signal line 110A is changed within a range of 60 to 120 [deg], and the signal lines 110B and 110C are changed within the range of 60 to 120 [deg], a trend in reflection loss appears as shown in FIG. 3. If ranges of the electrical lengths of the signal lines 110A to 110C in which a reflection loss is 20 [dB] or more are determined on the basis of this trend, the range of the electrical length of the signal line 110A becomes about 90 to 120 [deg]. In addition, the ranges of the electrical lengths of the signal lines 110B and 110C in which the reflection loss is 20 [dB] or more are about 70 to 110 [deg].

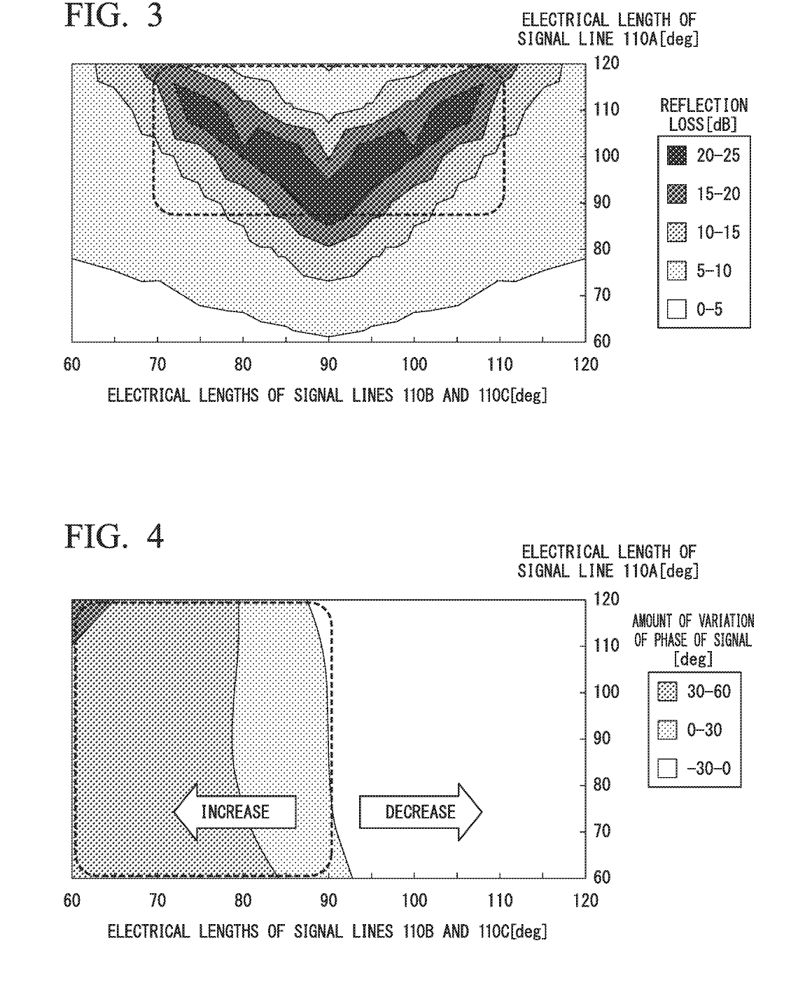

FIG. 4 is a diagram for describing an amount of variation of phase of signal when the electrical lengths of the signal lines 110B and 110C and the electrical length of the signal line 110A are changed. The horizontal axis of FIG. 4 represents electrical lengths [deg] of the signal lines 110B and 110C, and the vertical axis represents an electrical length [deg] of the signal line 110A.

When the signal line 110A is changed within the range of 60 to 120 [deg] and the signal lines 110B and 110C are changed within the range of 60 to 120 [deg], a trend in amount of variation of phase of signal [deg] appears as shown in FIG. 4. If the ranges of the electrical lengths of the signal lines 110A to 110C in which an amount of variation of phase of signal is increased are determined on the basis of this trend, the range of the electrical length of the signal line 110A is about 60 to 120 [deg], and the ranges of the electrical lengths of the signal lines 110B and 110C are about 60 to 90 [deg]. For this reason, the electrical length of the signal line 110A is set within the range of about 60 to 120 [deg] and the electrical lengths of the signal lines 110B and 110C are set within the range of about 60 to 90 [deg] to increase the amount of variation of phase of signal compared to the case in which the 90° hybrid-type phase shifter is used while obtaining a low reflection characteristic. Here, if the signal line 110A is compared with the signal line 110D, the electrical length of the signal line 110A has a larger value than the electrical length of the signal line 110D. As described above, the electrical lengths of the signal lines 110A to 110D are set under the conditions described above, and thereby the phase shifter 100 can increase the amount of variation of phase of signal compared to the case in which the 90° hybrid-type phase shifter is used while obtaining a low reflection characteristic.

Next, a method of determining the characteristic impedances of the signal lines 110A to 110D will be described. In the following, an example in which the characteristic impedance of the signal line 110A is set to Z₀=50 [Ω], the characteristic impedance Z₀ is set as a reference, and the characteristic impedances of other signal lines 110B to 110D are determined on the basis of simulation results will be described.

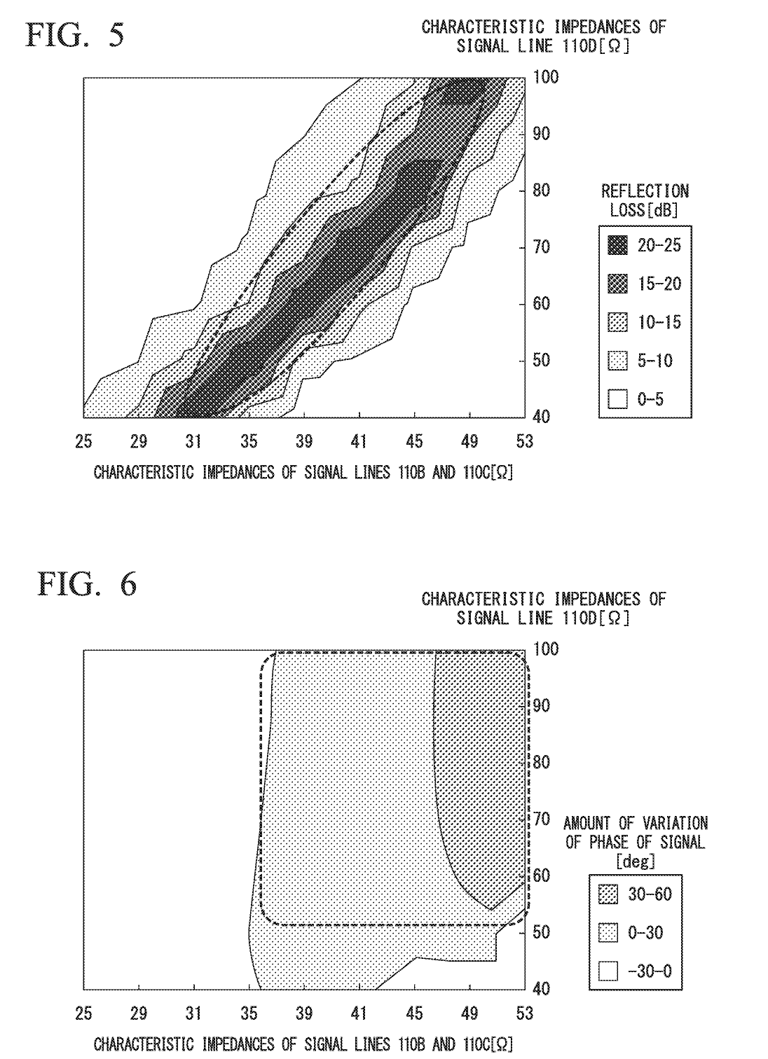

FIG. 5 is a diagram for describing a reflection loss when the characteristic impedances of each of the signal lines 110B and 110C and the characteristic impedance of the signal line 110D are changed. The horizontal axis of FIG. 5 represents the characteristic impedances [Ω] of the signal lines 110B and 110C, and the vertical axis represents the characteristic impedance [Ω] of the signal line 110D.

When the characteristic impedances of each of the signal lines 110B and 110C are changed within a range of 25 to 53 [Ω], and the characteristic impedance of the signal line 110D is changed within a range of 40 to 110 [Ω], the trend in reflection loss appears as shown in FIG. 5. If ranges of the characteristic impedances of the signal lines 110B to 110D in which the reflection loss is 20 [dB] or more are determined on the basis of the tendency, ranges of the signal lines 110B and 110C are about 30 to 49 [Ω]. In addition, a range of the signal line 110D in which the reflection loss is 20 [dB] or more is about 40 to 100 [Ω].

FIG. 6 is a diagram for describing the amount of variation of phase of signal when the characteristic impedance of the signal lines 1103 and 110C the characteristic impedance of the signal line 110D are changed. The horizontal axis of FIG. 6 represents the characteristic impedances [Ω] of the signal lines 110B and 110C, and the vertical axis represents the characteristic impedance [Ω] of the signal line 110D.

When the characteristic impedances of the signal lines 110B and 110C are changed within the range of 25 to 53 [Ω] and the characteristic impedance of the signal line 110D is changed within the range of 40 to 100 [Ω], a trend in amount of variation of phase of signal [deg] appears as shown in FIG. 6. If ranges of the characteristic impedances of the signal lines 110B to 110D in which an amount of variation of phase of signal is increased are determined on the basis of the tendency, the ranges of the characteristic impedance of the signal lines 1103 and 110C are about 35 to 53 [Ω], and the range of the electrical length of the signal line 110D is about a range of 50 to 110 [deg].

As a result, with regard to a range of characteristic impedance based on results of FIGS. 5 and 6, the characteristic impedances of the signal lines 110B and 110C are determined to be within a range larger than Z₀/√2 as compared with the characteristic impedance Z₀ of the signal line 110A, and the characteristic impedance of the signal line 110D is determined to be within a range larger than Z₀. Accordingly, it is possible to maintain a low reflection characteristic and to increase the amount of variation of phase of signal compared to the case in which the 90° hybrid-type phase shifter is used.

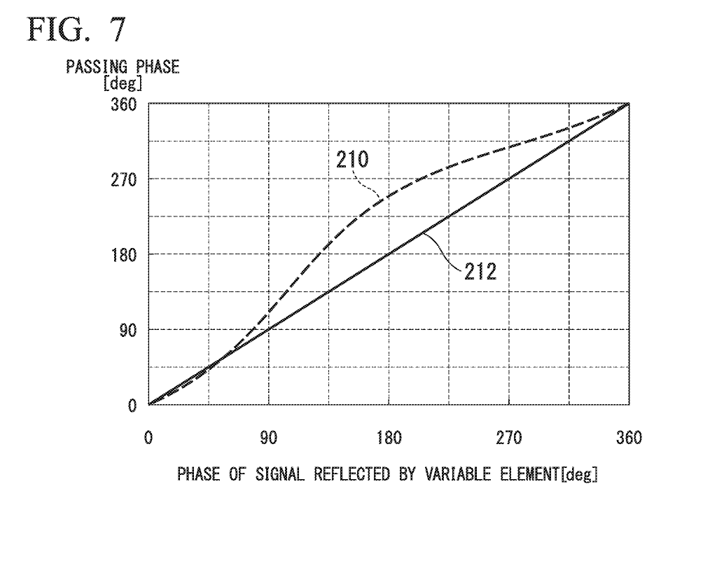

Next, a comparative example between the phase shifter 100 of the embodiment and a phase shifter of the related art will be described using drawings. FIG. 7 is a diagram which shows an example of comparing the passing phase in the phase shifter 100 of the embodiment and a phase shifter to be compared. The horizontal axis of FIG. 7 represents a phase of signal reflected by variable element [deg] and the vertical axis represents a passing phase [deg]. The signal lines 110A to 110D of the embodiment satisfy requirements for line conditions in terms of the electrical length and the characteristic impedance for the phase shifter 100 of the above embodiment. In addition, the phase shifter to be compared is the 90° hybrid-type phase shifter. The 90° hybrid-type phase shifter has different line conditions for the signal lines 110A to 110D from the phase shifter 100.

The phase shifter to be compared has the signal lines 110A to 110D with electrical lengths all the same as each other (for example, 90[deg]). In addition, the characteristic impedances of the signal lines 110A and 110D of the phase shifter to be compared are Z₀=50 [Ω] the same as each other, and the characteristic impedances of the signal lines 110B and 110C are Z₀/√2 [Ω] the same as each other.

Here, when the reflection phases of the phase variable elements 120A and 120B having an element resistance of 1 [Ω] are changed in a range of 0° to 360°, a trend in the passing phase appears as shown in FIG. 7. If a passing phase 210 of the phase shifter 100 of the embodiment is compared with a passing phase 212 of the phase shifter to be compared, while the passing phase of the phase shifter to be compared changes linearly with respect to change in the reflection phase of the phase variable element, the passing phase of the phase shifter 100 of the embodiment changes non-linearly. Moreover, it can be seen that the passing phase 210 when the phase shifter 100 of the embodiment is used increases at about 60 to 330 [deg] in the reflection phase of the phase variable elements 120A and 120B.

As can be seen from the comparative example shown in FIG. 7, it is possible to suppress an increase in size of a phase shifter by connecting the signal lines 110A to 110D satisfying requirements for line conditions of the embodiment, and to increase an amount of variation of phase of signal compared to the case in which the 90° hybrid-type phase shifter is used while obtaining a low reflection characteristic.

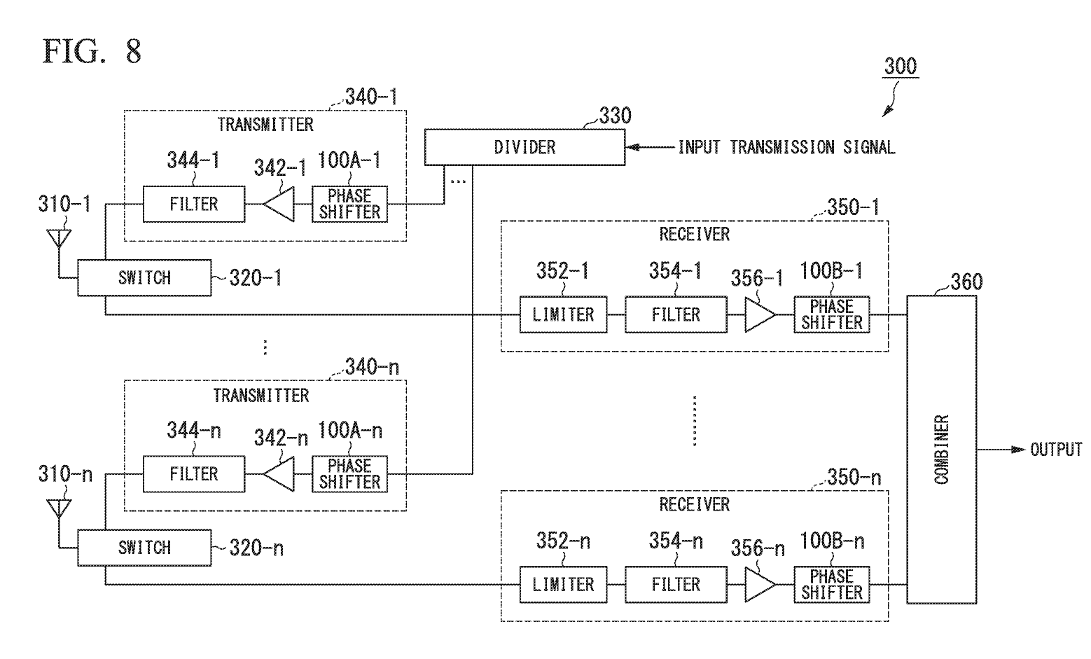

Next, an array antenna device including the phase shifter 100 of the embodiment will be described with reference to drawings. FIG. 8 is a diagram which shows a configuration example of an array antenna device 300 including the phase shifter 100 of the embodiment. The array antenna device 300 includes, for example, a plurality of antenna elements 310-1 to 310-n (n is a natural number of two or more), a plurality of switch 320-1 to 320-n, a divider 330, a plurality of transmitters 340-1 to 340-n, a plurality of receivers 350-1 to 350-n, and a combiner 360. In the following description, the plurality of antenna elements 310-1 to 310-n have the same configuration, and, when not distinguished, the number after the hyphen that indicates the antenna element will be omitted and the antenna element will be referred to as “antenna element 310” in the description. In addition, the same applies to other configurations described using a hyphen.

The antenna element 310 generates a radio wave for transmission on the basis of a transmission signal supplied from the switch 320 and outputs the generated radio wave into the airspace. Moreover, the antenna element 310 receives a radio wave arriving from the airspace and generates a received signal.

The switch 320 switches and connects the antenna 310 between and to any one of the transmitter 340 and the receiver 350. The switch 320 is, for example, a circulator or a coaxial switch.

The divider 330 divides a transmission signal to be input o the plurality of transmitter 340-1 to 340-n.

The transmitter 340 includes, for example, a phase shifter 100A, a power amplifier 342, and a filter 344. The phase shifter 100A performs predetermined phase control on the transmission signal input from the divider 330. For example, the phase shifters 100A-1 to 100A-n may adjust a phase of each transmission signal in accordance with a direction of beams emitted from respective corresponding antenna elements 310-1 to 310-n. In addition, the phase shifter 100A outputs a transmission signal after the phase control to the power amplifier 342.

The power amplifier 342 performs power amplification on the transmission signal input from the phase shifter 100A using a predetermined gain, and outputs the transmission signal after the power amplification to the filter 344. The filter 344 performs band-pass control which allows a predetermined frequency band component of the transmission signal input from the power amplifier 342 to pass therethrough, and outputs a transmission signal with suppressed undesired waves to the switch 320. Accordingly, the transmission signal is emitted into the airspace via the switch 320 from the antenna element 310.

The receiver 350 includes, for example, a limiter 352, a filter 354, a low noise amplifier 356, and a phase shifter 100B. The limiter 352 limits a signal level of a received signal which is received by the antenna element 310 and is input via the switch 320 to a predetermined level, and outputs the received signal after the level limitation to the filter 354.

The filter 354 performs the band-pass control which allows a predetermined frequency band component of the received signal input from the limiter 352 to pass therethrough, and outputs the transmission signal after the band-pass control to the low noise amplifier 356.

The low noise amplifier 356 amplifies the received signal input from the filter 354 having low noise and outputs the received signal after the amplification to the phase shifter 100B.

The phase shifter 100B performs predetermined phase control on the received signal input from the low noise amplifier 356. For example, the phase shifter 100B adjusts a phase of the received signal to be a phase in accordance with a direction of beams desired to be received in the phase control. The phase shifter 100B outputs the received signal after the phase control to the combiner 360.

The combiner 360 combines received signals input from a plurality of phase shifters 100B-1 to 100B-n and outputs a combined signal as a reception beam.

The array antenna device 300 may include the phase shifter 100 of the embodiment in at least one of the transmitter 340 and the receiver 350. It is possible to realize an array antenna device with higher sensitivity by including the phase shifter 100 (the phase shifters 100A and 100B in an example of FIG. 8) in the array antenna device 300 shown in FIG. 8.

According to at least one of the embodiments described above, the phase shifter 100 includes a signal input unit P1 supplied with a signal, a first signal line 110A whose one end is connected to the signal input unit P1, a signal output unit P2 connected to the other end of the first signal line 110A, a second signal line 110B and a third signal line 110C which branch from the first signal line 110A at different points, a fourth signal line 110D whose one end is connected to an end of the second signal line 110B on an opposite side to a branch point from the first signal line 110A and whose other end is connected to an end of the third signal line 110C on an opposite side to a branch point from the first signal line 110A, a first phase variable element 120A connected to a connection point between the second signal line 110B and the fourth signal line 110D, a second phase variable element 120B connected to a connection point between the third signal line 110C and the fourth signal line 110D, and a phase setter 130 connected to both the first phase variable element 120A and the second phase variable element 120B. The electrical length and the characteristic impedance of the second signal line 110B are the same as the electrical length and the characteristic impedance of the third signal line 110C, and at least one of the electrical length and the characteristic impedance of the first signal line 110A is different from the electrical length or the characteristic impedance of the fourth signal line 110D, and thereby it is possible to suppress an increase in size of a phase shifter and to increase an amount of change in a passing phase.

Although several embodiments of the present invention have been described, these embodiments are presented as an example, and are not intended to limit the scope of the invention. These embodiments can be implemented in various other forms, and various omissions, substitutions, and modifications can be performed in a scope not departing from the gist of the present invention. These embodiments and modifications thereof are included in the scope of the invention and the equivalents described in the scope of the claims as well as in the scope and the gist of the invention and the equivalents.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A phase shifter comprising:
a signal input unit configured to receive signal;
a first signal line having a first end and a second end, the first end being connected to the signal input unit;
a signal output unit connected to the second end,
a second signal line having a third end and a fourth end, the third end being connected to the signal input unit and the first end,
a third signal line having a fifth end and a sixth end, the fifth end being connected to the signal output unit and the second end,
a fourth signal line having a seventh end and a eighth end, the seventh end being connected to the fourth end, and the eighth end being connected to the sixth end,
a first phase variable element connected to a connection point between the second signal line and the fourth signal line;
a second phase variable element connected to a connection point between the third signal line and the fourth signal line; and
a phase setter connected to both the first phase variable element and the second phase variable element,
wherein the second signal line is identical in an electrical length and a characteristic impedance to the third signal line, and
wherein the first signal line is different in at least one of an electrical length and a characteristic impedance from the fourth signal line.

2. The phase shifter according to claim 1,
wherein the electrical length of the first signal line has a larger value than the electrical length of the fourth signal line.

3. The phase shifter according to claim 1,
wherein the characteristic impedance of the first signal line has a smaller value than the characteristic impedance of the fourth signal line.

4. The phase shifter according to claim 1,
wherein the first and the second phase variable elements are PIN diodes.

5. The phase shifter according to claim 1,
wherein the first and the second phase variable elements are varactor diodes.

6. The phase shifter according to claim 1,
wherein the first, second, third, and fourth signal lines contain a superconductor.

7. An array antenna device comprising:
a plurality of antenna elements;
a divider configured to divide a signal for each of the plurality of antenna elements;
a plurality of transmitters configured to change a phase of the signal divided by the divider and to output the signal to the plurality of antenna elements;
a plurality of receiver configured to change a phase of a received signal generated on the basis of radio waves reaching the plurality of antenna elements; and
a combiner configured to combine received signals from the plurality receivers,
wherein at least one of the transmitter and the receiver includes the phase shifter,
wherein the phase shifter comprises:
a signal input unit configured to receive signal;
a first signal line having a first end and a second end, the first end being connected to the signal input unit;
a signal output unit connected to the second end,
a second signal line having a third end and a fourth end, the third end being connected to the signal input unit and the first end,
a third signal line having a fifth end and a sixth end, the fifth end being connected to the signal output unit and the second end,
a fourth signal line having a seventh end and a eighth end, the seventh end being connected to the fourth end, and the eighth end being connected to the sixth end,
a first phase variable element connected to a connection point between the second signal line and the fourth signal line;
a second phase variable element connected to a connection point between the third signal line and the fourth signal line; and
a phase setter connected to both the first phase variable element and the second phase variable element,
wherein the second signal line is identical in an electrical length and a characteristic impedance to the third signal line, and
wherein the first signal line is different in at least one of an electrical length and a characteristic impedance from the fourth signal line.
